(19) United States
(12) Patent Application Publication
(10) Pub. No.: US 2010/0068602 A1
(43) Pub. Date: Mar. 18, 2010

(54) FUEL CELL STACK AND SEAL FOR A FUEL CELL STACK, AS WELL AS A PRODUCTION METHOD FOR IT

(75) Inventors: Christian Wunderlich, Chemnitz (DE); Andreas Reinert, Dresden (DE); Karl-Hermann Bucher, Hof (DE); Ralf Otterstedt, Goslar (DE); Hans-Peter Baldus, Koditz (DE); Michael Stelter, Chemnitz-Rohrsdorf (DE); Axel Rost, Dresden (DE); Mihails Kusnezoff, Dresden (DE)

Correspondence Address: FITCH EVEN TABIN & FLANNERY, 120 SOUTH LASALLE STREET, SUITE 1600, CHICAGO, IL, 60603-3406, US

(73) Assignee: Staxera GMBH, Dresden (DE)

(21) Appl. No.: 12/518,465

(22) PCT Filed: Nov. 5, 2007
(86) PCT No.: PCT/DE07/01983

§ 371 Date: Jul. 31, 2009

(30) Foreign Application Priority Data
Dec. 11, 2006 (DE) 102006058335.3

(51) Int. Cl. H01M 2/08

(52) U.S. Cl. 429/35; 29/623.1

(57) ABSTRACT

The invention relates to a sealing for the gas-tight connection of two elements of a fuel cell stack comprising an electrically non-conducting spacer component and at least one solder component solid or viscous over its entire extension at the operating temperature of the fuel cell stack and coupling the spacer component to at least one of the elements to be connected of the fuel cell stack in a gas-tight manner. According to the invention it is envisaged that the spacer component is formed of a ceramic material. The invention further relates to a fuel cell stack in which, according to the invention, it is envisaged that a distribution of forces compressing the fuel cell stack in the axial direction is directly transmitted to at least one of the elements to be connected by the spacer component. The invention further relates to production methods for seals and fuel cell stacks.

The invention relates to a sealing for a gas-tight connection of two elements of a fuel cell stack comprising an electrically non-conducting spacer component and at least one solder component solid or viscous over its entire extension at an operating temperature of the fuel cell stack and coupling the spacer component to at least one of the elements of the fuel cell stack to be connected in a gas-tight manner.

The invention further relates to a fuel cell stack comprising a plurality of repetitive units stacked in the axial direction and at least one sealing for a gas-tight connection of two elements of the fuel cell stack, the sealing comprising an electrically non-conducting spacer component and at least one solder component coupling the distance component to at least one of the elements to be connected of the fuel cell stack.

The invention further relates to a method for producing a sealing suitable for a gas-tight connection of two elements of a fuel cell stack, the sealing comprising an electrically non-conducting spacer component and at least one solder component solid or viscous over its entire extension at an operating temperature of the fuel cell stack and coupling the spacer component to at least one of the elements to be connected of the fuel cell stack in a gas-tight manner.

The invention also relates to a method for producing a fuel cell stack comprising a plurality of repetitive units stacked in an axial direction and at least one sealing for a gas-tight connection of two elements of the fuel cell stack, the sealing comprising an electrically non-conducting spacer component and at least one solder component solid or viscous over its entire extension at an operating temperature of the fuel cell stack and coupling the spacer component to at least one of the elements to be connected of the fuel cell stack in a gas-tight manner.

The invention also relates to a method for producing a fuel cell stack comprising a plurality of repetitive units stacked in an axial direction and at least one sealing for a gas-tight connection of two elements of the fuel cell stack, the sealing comprising an electrically non-conducting spacer component and at least one solder component coupling the spacercomponent to at least one of the elements to be connected of the fuel cell stack.

Planar high-temperature fuel cells (pSOFCs) for converting chemically bound energy into electric energy are known. In these system oxygen ions pass through a solid state electrolyte permeable only for them and react with hydrogen ions to form water on the other side of the solid state electrolyte. Since electrons cannot pass through the solid state electrolyte an electric potential difference is generated which can be used to carry out electric work if electrodes are attached to the solid state electrolyte and connected to an electric load. The combination of the two electrodes and the electrolyte is referred to as MEA (“membrane electrolyte assembly”). For technological applications a plurality of repetitive units consisting of MEA, fluid duct structures and electric contacts are combined to form a stack. The repetitive units comprise apertures through which the fluids pass to adjacent repetitive units. The boundaries of the repetitive units are referred to as bipolar plates.

The apertures in the bipolar plates have to be provided with seals so that the fluids within the stack do not mix. Various requirements relating to the seals arise from the operating principle of high-temperature fuel cells. The seals are required to be gas-tight in case of overpressures of up to approximately 0.5 bar, to be usable in a range from −30° C. to 1,000° C., thermally cyclisable and long-term stable for a lifetime of approximately 40,000 hours. Since the seals separate the fuel gas chamber from the air chamber they have to be formed of a material which is, on the one hand, reduction resistant and, on the other hand, oxidation resistant. If the seals are inserted between two repetitive units they also have to electrically insulate them with respect to each other since leakage currents in the stack reduce its performance. Besides the seals are in most cases disposed in the direct mechanical load path of the fuel cell stack exposed to a compressing restraining force and therefore have to transfer the applied restraining force from one repetitive unit to the next one. Said restraining force which may, for example, be realised by an external restraint of the fuel cell stack or weights above the stack is essential for a good internal electric contact of the individual components and therefore for the performance of the overall system.

The seals between the repetitive units and the electrolytes need not be formed so as to be electrically insulating since both components have the same electrical potential.

Instead, however, said seals are required to provide a gas-tight connection between two different materials, often between the two different material classes of metal and ceramics. This means that they need to be capable of resorbing or compensating the mechanical strains resulting from the different thermal expansion coefficients and heat capacities of the materials. The repetitive units or bipolar plates are frequently manufactured of ferritic high-temperature steels, oxide dispersion-solidified alloys (ODS alloys), chrome-based alloys or other high-temperature resistant materials and may be provided with protective layers in accordance with some embodiments. In most cases the electrolyte consists of yttrium stabilised zirconium oxide (YSZ), it may, however, also consist of other materials, such as, for example, scandium-, ytterbium- or cerium-stabilised zirconium oxide. An approximation of the thermal properties of the MEA and the bipolar plate could so far not be satisfyingly realised so that the joining is required to neutralise the different thermal properties.

For said joining connections only very few materials qualify due to the complex requirement profile. An option is mica seals as known, for example, from the WO 2005/024280 A1. In principle mica has the advantage that it renders compressible seals possible in which the joining partners are not rigidly connected to each other. In this way the expansion coefficient does not have to be precisely adjusted, the mica seals permitting slight relative movements among the parts to be joined. However, pure mica seals have high to very high leakage rates since two leakage paths exist for the fluids, one between the mica and the respective joining partners, and the other between the individual mica lamina. For sealing the two leakage paths there are different suggestions which, however, render the compressible mica seals ever more solid and rigid so that the desired compressible properties are lost.

A second problem relating to mica seals is the temperature change resistance. Examinations have revealed that well sealing mica connections show very high leakage rates after a few temperature cycles. The reason for this is the crushing of the individual mica lamina during the temperature cycles by which the leakage path through the mica is enlarged whereby the sealing properties are highly deteriorated.

Another option for sealing high-temperature fuel cells is the utilisation of glass or glass ceramics on the basis of SiO₂ containing major additions of barium oxide (BaO) and calcium oxide (CaO) which are referred to as barium or calcium silicate glasses. Said glasses are, on the one hand, chemically very stable and electrically insulating. Seals made of a glass solder are cost-effective in their production and may be readily applied to the bipolar plate using different techniques. Furthermore the glasses have a good compensation capacity in case of varying joining heights. In this way variations of the joining gap of up to 50 μm can be compensated without problems. For the adjustment of the thermal expansion coefficient of said glasses to that of the other materials of an SOFC the partial or complete crystallisation of the additions of Ba and/or Ca is used. In this way the low expansion coefficient of the pure glasses can be adjusted to the values of the other materials of the SOFCs. Since the glasses are overcooled smelts they will soften with an increasing temperature without having a defined point at which the viscosity suddenly changes as known from crystalline solids. This gives rise to the drawback that a glass seal in the load flow of a fuel cell stack may be more and more compressed with time until two adjacent bipolar plates contact and cause a short-circuit. The crystallisation of components of the glass smelt can, however, only partially and therefore insufficiently oppose said process so that in case of glass solders there will always be the problem that they become to soft for a use in SOFCs in case of high mechanical loads and/or high temperatures. The partially crystallised glass has a thermal expansion coefficient of approximately 9×10⁻⁶ K⁻¹ which is significantly lower than that of the metal of the bipolar plate (of approximately 12.5×10⁻⁶ K⁻¹). While this advantageously leads to the electrolyte remaining under pressure strain when bonding the electrolyte of the cell to the metal of the bipolar plate it will disadvantageously affect the load capacity of the connection between two bipolar plates. The tendency of the glass to form bubbles is of further disadvantage as it causes leakage and results in a limitation to a height of approximately 300 mm since the weight force to be applied for joining flattens the viscous glass. Further a sealing element is desirable the insulation resistance of which is greater than that of the joining glass used so far.

Settling can be prevented by introducing spacer elements as suggested, for example, in the DE 101 16 046 A1. In that case a preferably ceramic powder the powder grains of which have the size of the gap to be sealed and are therefore capable of bearing a load is added to the glass solder. This, however, will, according to the DE 101 16 046 A1, only work in case of small gap dimensions up to approximately 100 μm. In addition the powder grains have to be distributed very uniformly in the glass solder to accommodate the load uniformly. In case of pulverised spacer elements of this scale another problem occurs, namely the particle size distribution. This means that a powder having a rated particle diameter of, for example, 100 μm will always contain particles which are larger than 100 μm as well as particles the diameter of which will significantly fall short of 100 μm so that not all of the introduced powder but only a small part of it is available for the accommodation of a load. In this way the effectively used part of the powder preferably added to the glass solder in an amount of 10% is reduced. On the other hand it is impossible to set a defined gap width of 100 μm if some powder particles have a size of 110 or 120 μm. The use of powders having a very narrow particle size distribution is possible. These are, however, extremely expensive and therefore seem unsuitable for a serial production. Furthermore the round particles suggested in the DE 101 16 046 A1 transmit the load punctually. If such a sealing variant is applied to the MEA sealing this results in locally high mechanical surges in the MEA which might cause it to break. In the field of bipolar plates it might occur that the powder particles are pressed into the metal since its strength decreases with an increase of the temperature and that the metal is exposed to locally high mechanical stresses due to the few powder particles.

The sealing of the apertures is also realisable with metallic solders. The joining is, in this case, effected at high temperatures exceeding the melting temperature of the metal solder by wetting the joining surface with the liquid metal solder, the filling of the joining gap by capillary forces, and the solidification of the metal solder. A great advantage as compared to glass solders are the shorter joining times which can be realised with metal solders. If the joining takes place in an oven the heating and soldering time as well as the overall dwelling time of the components in the oven may be reduced by more than 60%. By using modern joining methods such as resistance soldering or induction soldering even shorter joining times are possible.

Said reduction of the joining time may be realised by a number of favourable parameters. On the one hand an increase of the heating rate may be made use of which may amount to up to 10 K/min in case of furnace soldering and to up to 300 K/min in case of induction heating. On the other hand cooling may be effected immediately after the end of the soldering time while in case of glass solders a time interval for the partial or complete crystallization is required to follow. Only in this way a load accommodation by the glass solders can be realised. The utilisation of solder films additionally shortens the joining process. Films of metallic solders do not contain any binding agent as they are either alloys or laminated individual films. Therefore the hold time for the removal of the binding agent may be eliminated as compared to glass solder films.

In general metal solders are used for mechanically stiff and electrically conductive connections like, for example, those suggested in the DE 198 41 919 A1 for contacting and attaching connecting elements to an anode. If two bipolar plates are to be joined using a metal solder an electric insulation of the components can only be realised by using insulating intermediate layers. Such an electrically non-conducting intermediate layer of a ceramic material in connection with metallic solder alloys which are liquid at the operating temperature of the fuel cell stack is known from the DE 101 25 776 A1.

From the DE 10 2004 047 539 A1 a sealing arrangement is known which comprises a metal substrate provided with an insulating ceramic coating. The thus available component provided with a ceramic surface is coupled to the elements to be connected using soldering or welding methods.

The soldering of ceramic materials differs from the soldering of metallic materials. Conventional solders are incapable of wetting ceramic materials. One approach consists in the metallization of ceramic components and the connection using a conventional soldering process. The metallization is, for example, carried out using the molybdenum-manganese method. A paste of, for example, molybdenum oxide and manganese is applied to a ceramic joining surface and sintered onto the ceramic surface at high temperatures (>1000° C.) in forming gas. For enhancing the wettability the metallized ceramic is additionally provided with a nickel or copper coating. The ceramic material metallized in this way can now be soldered using conventional metal solders in a following step.

Another alternative for joining ceramic materials is the active solder technology. In that single step process the wetting of the ceramic surface is achieved by using specific “activated” solder materials. Said metallic alloys contain small amounts of boundary surface-active elements like titanium, hafnium or zirconium and are therefore capable of wetting ceramic surfaces.

The described techniques enable mechanically stable and gas-tight connections between ceramics and ceramics or ceramics and metal. In general the different thermal expansion coefficients of the materials to be joined have to be taken into consideration when soldering the combination of ceramics and metal. The metal solder can intercept shear stresses in the joining gap depending on the thickness of the solder due to its ductility. Furthermore the expansion coefficient of the metals is greater than the expansion coefficient of the ceramic material in most cases. This results in the ceramic material being exposed not to tensile stress but to compressive stress. A failure of the ceramic material due to tensile stress is therefore excluded.

The invention is based on the object to provide a sealing and a fuel cell stack so that enhancements and simplifications are realised with respect to the tightness, stability and the production methods used.

The invention is based on the generic sealing in that the spacer component consists of a ceramic material. If, for example, two bipolar plates are to be joined using the sealing according to the invention the result is a tight, electrically well insulating, stable, thermally strainable and at the same time simple structure. As compared to a structure in which the spacer component is formed of a ceramic coated metal fewer process steps are required for producing the sealing. Further the thermal behaviour of the spacer component is exclusively determined by the thermal properties of the ceramic material.

It may, for example, be envisaged that the at least one solder component comprises a glass solder.

It is also feasible that the at least one solder component comprises a metal solder.

It may also be envisaged that the at least one solder component comprises an active solder.

According to a particularly preferred embodiment of the present invention it is envisaged that the spacer component comprises at least one recess filled with the solder component. The recesses are capable of accommodating solder before the sealing is coupled to the elements to be connected. The sealing is therefore easy to handle as a spacer component comprising solder introduced into recesses. Since the solder can be positioned in the range of the recesses in this way other areas of the surfaces facing the elements to be connected in the fuel cell stack may be free of solder. Therefore the distance between the elements to be connected is determined by the spacer component since the solder-free surfaces of the spacer component contact the elements to be connected directly, i.e. without an intermediate solder layer.

Conveniently it is envisaged that the solder component has a greater volume than the recess. In this way the solder can protrude beyond the surface towards the elements to be connected. The solder is therefore exposed to a load during the joining phase so that the isotropic sintering shrinkage of the solder is converted into a pure height shrinkage. After the sintering phase the solder flows viscously until the bipolar plates are in abutment with the spacer element. Accordingly the spacer element transmits the major part of the load. While in structures in which the joining of the bipolar plates is fully achieved using glass solder there is the risk of a short-circuit of adjacent bipolar plates due to a compression of the glass solder this is excluded in the present structure comprising the spacer component and the solder component since the rigid spacer components fully exclude any contact between adjacent bipolar plates.

It may, for example, be envisaged that the recess extents along an edge of the spacer component.

For example, it is possible that the recess extends along an edge of the spacer component. In this way the solder can flow away from the contact surface of the spacer component during the joining phase.

It is also possible that the recess is disposed in a surface facing an element to be connected and vertically bordered by the surface with respect to the extension of the solder component. Such a structure can be advantageous in view of the fact that the solder components are fixed by the spacer components on both sides.

It is particularly useful that the coupling of the spacer component to at least one of the elements to be connected is effected by means of a plurality of solder joints each of which provides a gas-tight connection in an intact state. In this way the risk of a failure of the sealing is reduced. In a glass solder cracks may be generated in case of temperature changes below the transition temperature, i.e. in the state in which the glass is practically fully solid. Cracks generated in this temperature range will immediately migrate through the entire cross section of the solder. If the hydrogen- and oxygen-containing gasses are then introduced into the fuel cell a fire is caused at these positions. Due to the local overheating occurring thereby the adjacent areas are then also damaged so that the whole fuel cell system may break down. By using glass solder with a plurality of solder joints generally only one of the solder joints will fail when subjected to mechanical stress. The crack can then only penetrate a second solder joint if a weak point of the second solder joint is present in the vicinity of the crack in the first solder joint. This is highly improbable so that a tight overall connection will survive. Furthermore the glass can heal the crack by viscous flowing when the fuel cell is brought to the operating temperature, particularly if the operating temperature is higher than the transition temperature of the glass. The arrangement of two or more solder joints which is particularly advantageous in case of glass solder can also be advantageous if metal solder is used.

Furthermore it may be envisaged that the solder component extends across the entire surface facing an element to be connected. After coupling the solder component to the elements to be connected an intermediate solder layer is created, or the solder component is forced to the outside by the application force so that in this case also eventually solder joints extending along the edges are obtained in case of a solder component distributed over the entire surface. If an intermediate solder layer remains a very safe connection comparable to a solution using a plurality of adjacent solder joints is obtained with respect to the tightness.

It may be envisaged that the spacer component carries a metal solder component on a surface facing an element to be connected and a glass solder component on the opposing surface. The joining of the spacer component and the elements to be connected is carried out in two steps due to the two different solder systems. First the previously metallized spacer element is soldered to one of the elements to be connected using a metal solder or directly using an active solder process. In this way the spacer element is, on the one hand, already positioned. On the other hand the tightness of the now already existing connection may be examined. If the sealing is soldered to a bipolar plate and the membrane electrode arrangement is already attached to the bipolar plate it is possible to examine the whole repetitive unit with respect to tightness in this state. It can thus be ensured that only intact components are assembled to form a fuel cell stack. Only after a successful examination of the tightness the joining of the repetitive units via the glass solder connections is effected.

It may be envisaged that the spacer component is sintered in a gas-tight manner.

On the basis of a ceramic material produced in this or another manner it is possible that the spacer component has an axial thickness of 0.1 to 0.2 mm.

It is particularly useful that the spacer component has an axial thickness of 0.3 to 0.8 mm.

Furthermore it may be envisaged that the solder component has an axial thickness of 0.02 to 0.2 mm.

For enhancing the connection between the spacer component and the solder component it is, conveniently, envisaged that the surface of the spacer component bearing the solder component is roughened.

Advantageously it is envisaged that the spacer component has a thermal expansion coefficient in the range of 10.5 to 13.5×10⁻⁶ K⁻¹. In this way it is ensured that the thermal expansion coefficient is better adjusted to the thermal expansion coefficient of ferritic steel than conventionally used joining glasses. Ferritic steel has a thermal expansion coefficient of 12 to 13×10⁻⁶ K⁻¹. A typical joining glass solder has a thermal expansion coefficient of 9.6×10⁻⁶ K⁻¹.

It may, for example, be envisaged that the spacer component comprises at least one of the following materials: barium disilicate, calcium disilicate, barium calcium orthosilicate. Said ceramic materials all have a thermal expansion coefficient in the range of 12×10⁻⁶ K⁻¹ and are therefore particularly suitable for use in connection with the present invention.

It is also possible that the spacer component comprises partly stabilised zirconium oxide. Partly stabilised zirconium oxide is zirconium oxide containing 2.8 to 5 mol % rare earth metal oxide, i.e. Y₂O₃, Sc₂O₃, MgO or CaO. Such systems have a thermal expansion coefficient of approximately 10.8×10⁻⁶ K⁻¹.

It is possible that aluminium oxide is added to the partly stabilised zirconium oxide.

In case of a metal solder for coupling the spacer element to the elements to be connected it is envisaged that the solder component comprises at least one of the following materials: gold, silver, copper.

The invention further relates to a fuel cell stack comprising a sealing according to the invention.

The invention is based on a generic fuel cell stack in that a distribution of forces compressing the fuel cell stack in the axial direction is directly transmitted to at least one of the elements to be connected by the spacer component. In this way the distance between the adjacent elements to be connected can be precisely adjusted by the spacer element. The rigid spacer element accommodates the load without the mediation of solder components during the operation of the fuel cell stack. The load path therefore does no longer pass through the solder components providing the sealing effect but through the rigid element. Thereby a contact of the elements to be connected due to a compression of the solder which would lead to a short-circuit in case of bipolar plates to be connected is prevented.

Conveniently it is envisaged that the spacer component is formed of a ceramic material. Even if in connection with the direct contacting of the elements to be connected and the spacer element any altogether non-conducting spacer elements may be used it is particularly advantageous to produce the spacer component of a ceramic material. This results in the particularities and advantages already mentioned in connection with the sealing according to the invention. This also applies to the particularly advantageous embodiments of the fuel cell stack according to the invention described below.

It may, for example, be designed so that the at least one solder component comprises a glass solder.

Further it may be envisaged that the at least one solder component comprises a metal solder.

It is also possible that the at least one solder component comprises an active solder.

According to another embodiment of the fuel cell stack according to the invention it is formed so that the spacer component is provided with at least one recess filled with the solder component.

In this connection it is particularly advantageous that the solder component has a larger volume than the recess.

Preferably the recess extends along an edge of the spacer component.

Further it may be useful that the recess is disposed in a surface facing an element to be connected and vertically bordered by the surface with respect to the extension of the solder component.

In view of a reliable sealing of the fuel cell stack it is envisaged that the coupling of the spacer component to at least one of the elements to be connected is effected by means of a plurality of solder joints each of which provides a gas-tight connection in an intact state.

A reliable sealing can also be provided by having the solder component cover the entire surface facing an element to be connected.

In connection with a series production of the fuel cell stack in which first the repetitive units are produced and examined with respect to tightness and only then the stack is formed it may be useful that the spacer component bears a metal solder component on a surface facing an element to be connected and a glass solder component on the opposing surface.

It may be useful that the spacer component is soldered in a gas-tight manner.

In this case the spacer component preferably has an axial thickness of 0.1 to 0.2 mm.

It is particularly preferable that the spacer component has an axial thickness of 0.3 to 0.8 mm.

Conveniently it is envisaged that the solder component has an axial thickness of 0.02 to 0.2 mm.

The fuel cell stack can be provided with a stable and tight structure by roughening the surface of the spacer component bearing the solder component.

A further advantage is that the spacer component has a thermal expansion coefficient in the range of 10.5 to 13.5×10⁻⁶ K⁻¹.

This may be realised by the spacer component comprising at least one of the following materials: barium disilicate, calcium disilicate, barium calcium orthosilicate.

Further it may be envisaged that the spacer component comprises partly stabilised zirconium oxide.

It is also possible that aluminium oxide is added to the partly stabilised zirconium oxide.

Further it may be envisaged that the solder component comprises at least one of the following materials: gold, silver, copper.

The invention further relates to a sealing for a fuel cell stack according to the invention, i.e. a sealing comprising an altogether non-conductive spacer element and solder components arranged thereon.

The invention is based on the generic method for producing a sealing in that the solder component is manufactured of a ceramic material. This results in the advantages and particularities already mentioned in connection with the sealing according to the invention.

In view of the production method it may be useful that the spacer component is produced by dry pressing of ceramic powder.

It may also be envisaged that the spacer component is produced by film casting, laminating and stamping.

On the basis of such a spacer component it may be envisaged that a glass solder in the form of a stamped film is applied to the spacer component.

It is also possible that a glass solder or a metal solder in the form of a paste is applied to the spacer component.

For enhancing the connection between the metal solder component and the spacer component it may be envisaged that a bonding layer is applied to the spacer component previous to the application of the metal solder.

In this connection it may further be useful that the spacer component is roughened before the application of a solder.

The invention is based on the generic method for producing a fuel cell stack in that a spacer component made of a ceramic material is used.

The advantages and particularities already mentioned in connection with the fuel cell stack according to the invention are therefore also realised within the framework of a production method for such a fuel cell stack.

It may be further developed so that elements of the fuel cell stack and seals comprising solder components of glass solder are stacked and the elements to be connected are then simultaneously connected to each other via the seals. Therefore a production method is possible in which a parallel connection of all coupling areas contacting the sealing components is effected.

At the same time, however, a serial production is also possible, particularly if repetitive units and seals comprising solder components of metal solder are successively connected to each other one after the other.

Advantageously it may further be envisaged that seals are used the spacer components of which bear a metal solder component on a surface facing an element to be connected and a glass solder component on the opposing surface, that the spacer components are first connected to elements of the fuel cell stack via the metal solder components, that the repetitive units are completed, that the repetitive units are stacked, and that the repetitive units are connected to each other via the glass solder components.

Such a production on the basis of a sealing comprising different solder systems is useful particularly in view of the fact that the repetitive units are examined with respect to tightness after joining the spacer components with elements of the fuel cell stack via the metal solder components.

The invention is based on another generic method for producing a fuel cell stack in that the solder components are disposed on the spacer components so that a distribution of forces compressing the fuel cell stack in the axial direction is directly transmitted to at least one of the elements to be connected by the spacer component. In that production method principally different spacer components can be used as long as they are electrically insulating. Even if the use of ceramic materials is particularly advantageous it is not necessarily envisaged.

Like in connection with the production method according to the invention based on a ceramic spacer component it may also be envisaged in this case that elements of the fuel cell stack and seals comprising solder components of glass solder are stacked and that the elements to be connected are then simultaneously connected to each other via the seals.

Further it is useful that repetitive units and seals comprising solder components of metal solder are successively connected to each other one after the other.

In addition it may be advantageous that seals are used the spacer components of which bear a metal solder component on a surface facing an element to be connected and a glass solder component on the opposing surface, that the spacer components are first connected to elements of the fuel cell stack via the metal solder components, that the repetitive units are completed, that the repetitive units are stacked, and that the repetitive units are connected to each other via the glass solder components.

This again is advantageous in connection with the repetitive units being examined with respect to tightness after connecting the spacer components to elements of the fuel cell stack via the metal solder components and before stacking the repetitive units.

The invention will now be explained by way of example resorting to particularly preferred embodiments with reference to the accompanying drawings in which:

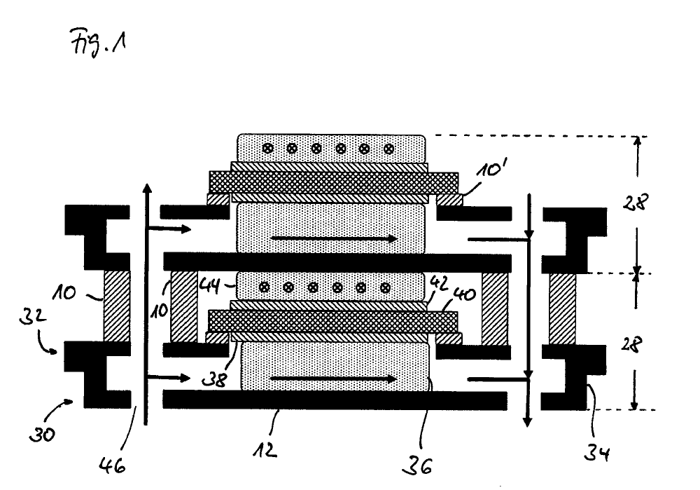

FIG. 1 is an axial cross section of a part of a fuel cell stack according to the invention;

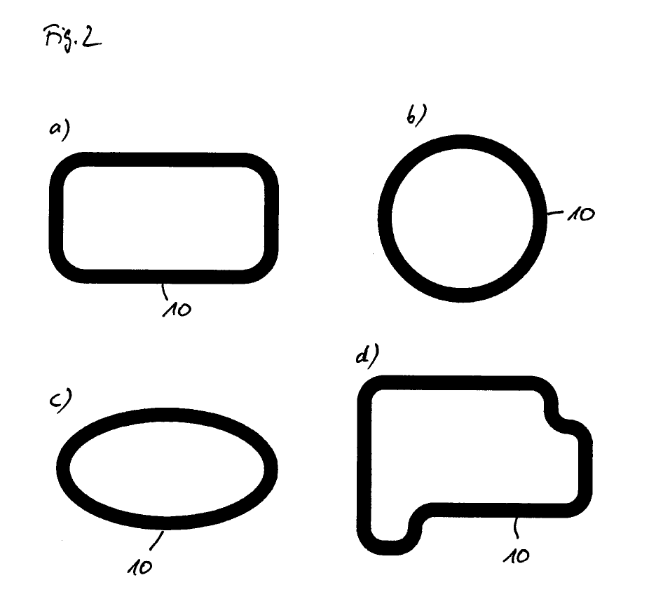

FIG. 2 shows different plan views of seals;

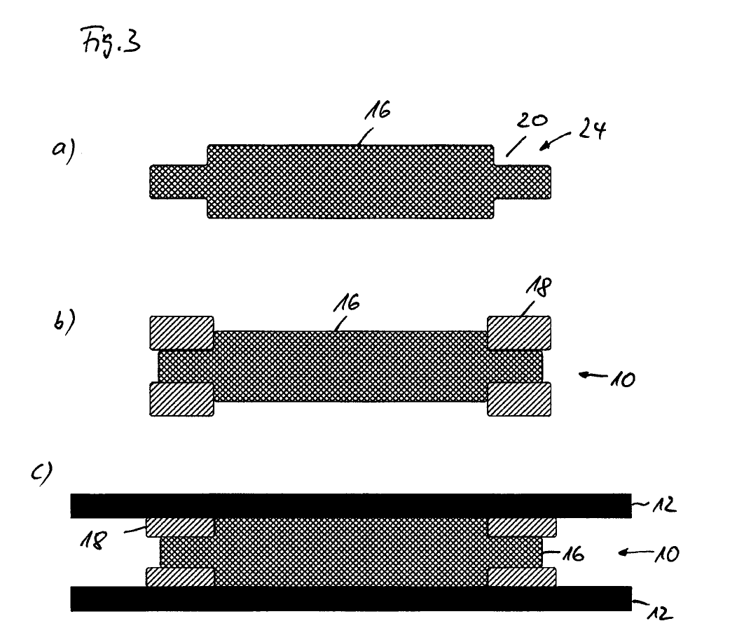

FIG. 3 shows different axial cross sections for describing a sealing according to the invention as well as production methods according to the invention for producing a sealing and a fuel cell stack;

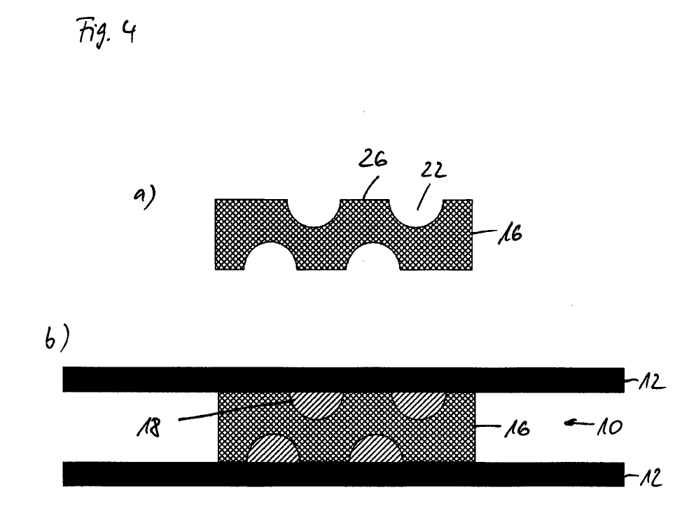

FIG. 4 shows different axial cross sections for describing another embodiment of a sealing according to the invention as well as for explaining production methods for producing seals according to the invention and fuel cell stacks according to the invention;

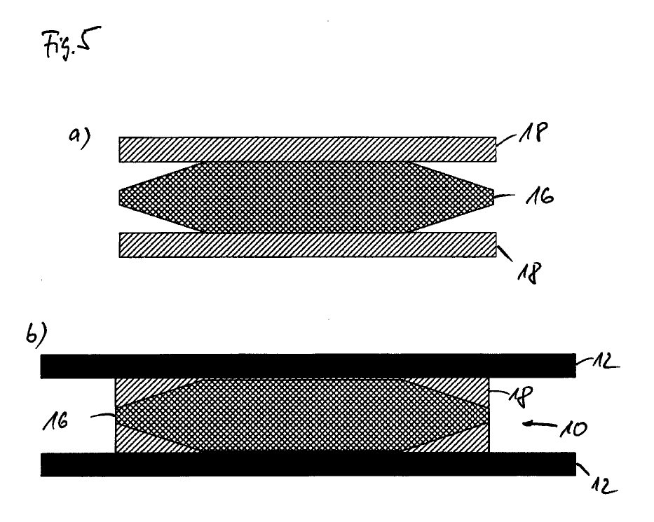

FIG. 5 shows different axial cross sections for describing another embodiment of a sealing according to the invention as well as for explaining production methods for producing seals according to the invention and fuel cell stacks according to the invention;

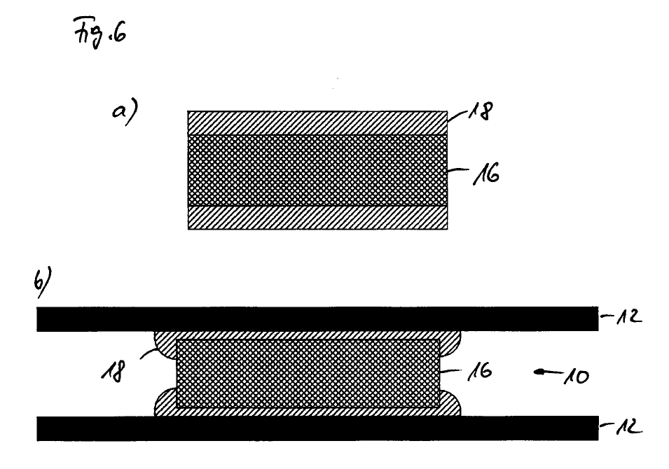

FIG. 6 shows different axial cross sections for describing another embodiment of a sealing according to the invention as well as for explaining production methods for producing seals according to the invention and fuel cell stacks according to the invention;

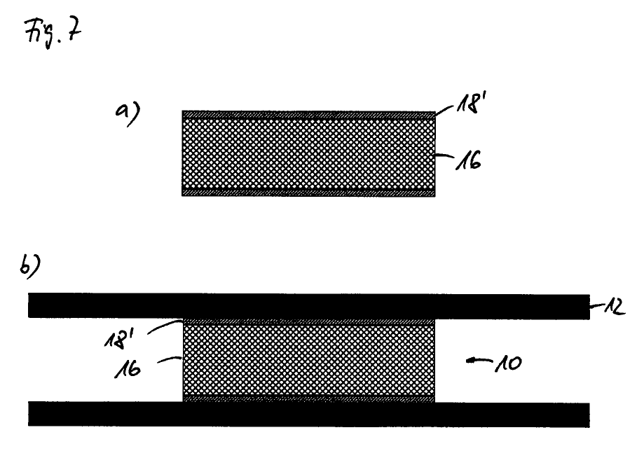

FIG. 7 shows different axial cross sections for describing another embodiment of a sealing according to the invention as well as for explaining production methods for producing seals according to the invention and fuel cell stacks according to the invention; and

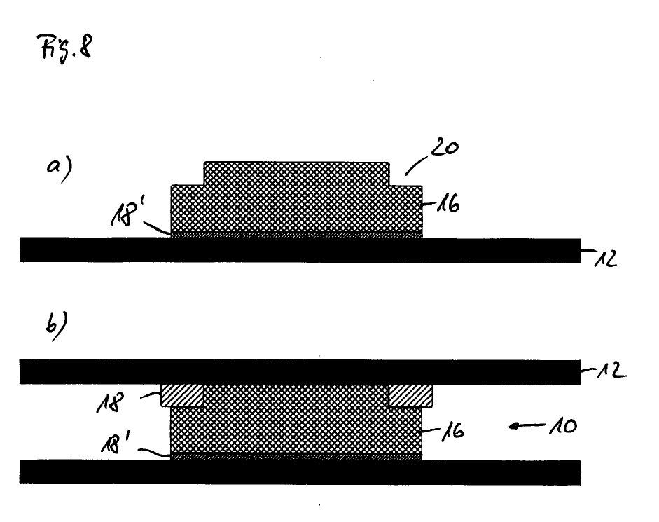

FIG. 8 shows different axial cross sections for describing another embodiment of a sealing according to the invention as well as for explaining production methods for producing seals according to the invention and fuel cell stacks according to the invention.

In the following description of the preferred embodiments of the present invention identical reference numerals designate identical or comparable components.

FIG. 1 shows an axial cross section of a part of a fuel cell stack according to the invention. Two repetitive units 28 of a fuel cell stack are shown. Each of said repetitive units 28 comprises a bipolar plate 12. It defines a main plane 30 and a secondary plane 32 axially displaced relative to it. The plate portions disposed in the main plane 30 and in the secondary plane 32 extend in the radial direction, and they are connected to each other via axial portions 34. This results in a cartridge-like structure which is altogether electrically conductive. A part of the bipolar plate 12 disposed in the main plane 30 is followed by a first gas duct range 36. Said gas duct range is provided for guiding the gasses reacting in the fuel cell stack. Further it provides an electric contact between the bipolar plate 12 and a first electrode 38 of a membrane electrode arrangement 38, 40, 42. A solid state electrolyte 40 is disposed above the first electrode 38. This solid state electrolyte 40 is again followed by a second electrode 42. The second electrode 42 is followed by a further gas duct area 44. If the first electrode 38 is a cathode the lower gas duct range 36 serves to guide air while the upper gas duct range 44 guides hydrogen to be supplied to the adjacent anode 42. To introduce air into the lower gas duct ranges 36 axial air passages 46 are provided. On the one hand the seals 10, 10′ prevent air from flowing into the range of the upper gas duct ranges 44 and thus the anodes 42. Likewise the seals 10 prevent air from escaping form the fuel cell stack. Another image is obtained when regarding another cross sectional view of the fuel cell stack. In such a view axial passages for supplying hydrogen to be supplied to the upper gas duct ranges 44 and thus to the anodes 42 would be recognisable while the lower gas duct ranges 36 as well as the cathodes are protected from the hydrogen by seals. The seals 10 connecting the bipolar plates 12 to each other all have to be formed of an electrically non-conductive material since the sides of two adjacent bipolar plates 12 facing each other have opposite potentials. The sealing 10 described within the framework of the present invention is mainly provided for said connection of the bipolar plates 12. However, other seals required in the fuel cell stack, for example the seals 10′ between the solid state electrolytes 40 and the bipolar plates 12, may also be designed in the same manner.

FIG. 2 shows different plan views of seals. The direction of view is vertical to the direction of view in FIG. 1. Different forms of seals are shown which, for example, extend along the entire circumference of the fuel cell stack. A rectangular (FIG. 2a), a circular (FIG. 2b), an elliptical (FIG. 2c) and a partly concave (FIG. 2d) sealing shape are recognisable. The seals may also have apertures, for example to seal an axial passage provided as a fluid duct on both sides, i.e. particularly with respect to the atmosphere and the gas duct range which should not be reached by the gasses guided in the fluid duct.

FIG. 3 shows different axial cross sections for describing a sealing according to the invention as well as production methods according to the invention for producing a sealing and a fuel cell stack. In FIG. 3a a spacer component 16 of a sealing 10 according to the invention is shown. On its edges 24 the spacer component 16 is provided with recesses 20 capable of accommodating a solder component 18. A spacer component 16 with an introduced solder component 18 is shown in FIG. 3b. The spacer component 16 and the solder components 18 together form the sealing 10. FIG. 3c shows the sealing 10 in a sealed state between two bipolar plates 12. As can be seen in FIG. 3b the solder component, for example a glass solder, protrudes beyond the spacer element 16. During the joining phase, i.e. during the transition to the state shown in FIG. 3c, the solder component 18 is therefore exposed to a load. In this way the isotropic sinter shrinkage can be converted into a pure height shrinkage. After the sintering phase the glass flows viscously until the bipolar plates 12 are in abutment with the spacer element 16. A restraining force acting on the fuel cell stack is then substantially transmitted via the spacer component 16. Since a plurality of solder joints 18, in the illustrated case, by way of example, two solder joints, face each bipolar plate 12 a defect of one of the solder joints 18 does not yet render the system leaky.

FIG. 4 shows different axial cross sections for describing another embodiment of a sealing according to the invention as well as for explaining production methods for producing seals according to the invention and fuel cell stacks according to the invention. The spacer element 16 according to FIG. 4a comprises recesses 22 provided in the surface 26 of the spacer component 16 which is coupled with the bipolar plate 12. The coupled state is shown in FIG. 4d, the solder component 18 being additionally introduced into the recesses 22 in this case. In this variant the solder component 18, i.e. particularly the glass solder, is completely surrounded by the spacer element so that it is fixed in the joining and sealing area.

FIG. 5 shows different axial cross sections for describing another embodiment of the sealing according to the invention as well as for explaining production methods for producing seals according to the invention and fuel cell stacks according to the invention. Here the solder component 18 is applied to the entire surface of the spacer component 16. The spacer component 16 is, in this case, formed so that during the transition from the state shown in FIG. 5a to the state according to FIG. 5b, i.e. during joining, a volume is provided into which the solder component 18 can be displaced. In this way it is possible that the spacer component 16 directly contacts the bipolar plates 12 in the joint state despite of the arrangement of the solder component on the entire surface of the spacer component 16.

FIG. 6 shows different axial cross sections for describing another embodiment of the sealing according to the invention as well as for explaining production methods for producing seals according to the invention and fuel cell stacks according to the invention. As solder component 18 a glass solder is provided. The embodiment is comparable to the embodiment according to FIG. 5 even though here the spacer component 16 has no particular form in view of the accommodation of the solder component 18. According to FIG. 6a the solder component 18 is applied to the entire surface of the spacer component 16. As can be seen in FIG. 6b a part of the solder component 18 will remain between the spacer component 16 and the bipolar plates 12 after joining. The remainder is displaced towards the towards the edge regions. The amount of solder forming the intermediate layer can be so small that the distribution of forces between the bipolar plate 12 and the spacer component 16 is practically hardly any less direct than in a case in which the spacer component 16 directly contacts the bipolar plate 12.

FIG. 7 shows different axial cross sections for describing another embodiment of the sealing according to the invention as well as for explaining production methods for producing seals according to the invention and fuel cell stacks according to the invention. As solder component 18′ a metal solder is provided. Otherwise the embodiment according to FIG. 7 is identical to the embodiment according to FIG. 6. The soldering process may either be a two-stage process in which first a metallization of the spacer element 16 effected whereupon soldering is carried out using a conventional metal solder. It is also possible to carry out a one-stage active solder process.

FIG. 8 shows different axial cross sections for describing another embodiment of the sealing according to the invention as well as for explaining production methods for producing seals according to the invention and fuel cell stacks according to the invention. Here a hybrid solder system is illustrated. Previous to the state shown in FIG. 8a there is a spacer component 16 comprising recesses 20 provided on one side in the edges of the spacer component 16. It will then be provided with a metal solder component 18′ on the side opposing the recesses 20. The thus given partial sealing may then be soldered onto a bipolar plate 12. In this state the tightness test on the connection between the spacer component 16 and the bipolar plate 12 via the metal component 18′ may be carried out. Preferably the bipolar plates thus provided with the partial seals are prefabricated for the entire fuel cell stack to then introduce a glass solder component 18 into the recesses 20 of the spacer component 16. The fuel cell stack may then be assembled, and the connections between the spacer components 16 and the bipolar plates 12 via the glass solder components 18 may then be coupled in parallel for the entire stack.

The features of the invention disclosed in the above description, in the drawings as well as in the claims may be important for the realisation of the invention individually as well as in any combination.

### LIST OF REFERENCE NUMERALS

10 sealing
10′ sealing
12 bipolar plate
16 spacer component
18 solder component
18′ solder component
20 recess
22 recess
24 edge
26 surface
28 repetitive unit
30 main plane
32 secondary plane
34 axial portions
36 gas duct range
38 electrode
40 solid state electrolyte
42 electrode
44 gas duct range
46 air passage

1-63. (canceled)

64. A sealing for the gas-tight connection of two elements of a fuel cell stack comprising an electrically non-conducting spacer component and at least one solder component solid or viscous over its entire extension at the operating temperature of the fuel cell stack and coupling the spacer component to at least one of the elements to be connected of the fuel cell stack in a gas-tight manner, wherein the spacer component is formed of a ceramic material.

65. The sealing of claim 64, wherein the spacer component comprises at least one recess filled with the solder component.

66. The sealing of claim 65, wherein the solder component has a greater volume than the recess.

67. The sealing of claim 65, wherein the recess extends along an edge of the spacer component.

68. The sealing of claim 65, wherein the recess is disposed in a surface facing an element to be connected and vertically bordered by the surface with respect to the extension of the solder component.

69. A fuel cell stack comprising at least one sealing of claim 64.

70. A fuel cell stack comprising a plurality of repetitive units stacked in the axial direction and at least one sealing for connecting two elements of the fuel cell stack in a gas-tight manner, the sealing comprising an electrically non-conductive spacer component and at least one solder component coupling the spacer component to at least one of the elements to be connected of the fuel cell stack, wherein a distribution of forces compressing the fuel cell stack in the axial direction is directly transmitted to one of the elements to be connected by the spacer component.

71. A fuel cell stack of claim 70, wherein the spacer component comprises at least one recess filled with the solder component.

72. A fuel cell stack of claim 71, wherein the solder component has a greater volume than the recess.

73. A fuel cell stack of claim 71, wherein the recess extends along an edge of the spacer component.

74. A fuel cell stack of claim 71, wherein the recess is disposed in a surface facing an element to be connected and vertically bordered by the surface with respect to the extension of the solder component.

75. A method for producing a sealing capable of connecting two elements of a fuel cell stack in a gas-tight manner, the sealing comprising an electrically non-conductive spacer component and at least one solder component solid or viscous over its entire extension at the operating temperature of the fuel cell stack and coupling the spacer component to at least one of the elements to be connected of the fuel cell stack in a gas-tight manner, wherein the spacer component is formed of a ceramic material.

76. A method for producing a fuel cell stack comprising a plurality of repetitive units stacked in an axial direction and at least one sealing for connecting two elements of the fuel cell stack in a gas-tight manner, the sealing comprising an electrically non-conducting spacer component and at least one solder component solid or viscous over its entire extension at the operating temperature of the fuel cell stack and coupling the spacer component to at least one of the elements to be connected of the fuel cell stack in a gas-tight manner, wherein a spacer component made of a ceramic material is used.

77. The method of claim 76, wherein:
seals are used the spacer components of which bear a metal solder component on a surface facing an element to be connected and a glass solder component on the opposing surface,
the spacer components are first connected to elements of the fuel cell stack via the metal solder components,
the repetitive units are completed,
the repetitive units are stacked, and
the repetitive units are connected to each other via the glass solder components.

78. A method for producing a fuel cell stack comprising a plurality of repetitive units stacked in an axial direction and at least one sealing for connecting two elements of the fuel cell stack in a gas-tight manner, the sealing comprising an electrically non-conducting spacer component and at least one solder component coupling the spacer component to at least one of the elements to be connected of the fuel cell stack, wherein the solder components are arranged on the spacer components so that a distribution of forces compressing the fuel cell stack in the axial direction is directly transmitted to at least one of the elements to be connected by the spacer component.

79. The method of claim 78, wherein:
seals are used the spacer components of which bear a metal solder component on a surface facing an element to be connected and a glass solder component on the opposing surface,
the spacer components are first connected to elements of the fuel cell stack via the metal solder components,
the repetitive units are completed,
the repetitive units are stacked, and
the repetitive units are connected to each other via the glass solder components.
